(19) United States
(12) Patent Application Publication
(10) Pub. No.: US 2005/0191962 A1
(43) Pub. Date: Sep. 1, 2005

(54) Media player

(76) Inventors: Jao-Ching Lin, Hsin Chuang (TW); Tien-Shun Ma, Hsin Chuang (TW)

Correspondence Address: Ann Tsai, 931 West 75th Street, Suite 137, PmB 174, Naperville, IL, 60565, US

(21) Appl. No.: 10/773,049

(22) Filed: Feb. 6, 2004

(51) Int. Cl. H04B 7/00; H04B 3/00

(52) U.S. Cl. 455/41.2

(57) ABSTRACT

The present invention relates to a media player includes a processing unit, a reading unit, a converting unit and a transmitting unit. Digital audio data from external storage media is read by said reading unit, converted through digital/analog/RF conversion by the converting unit under the control of the processing unit, and then emitted by the emitting unit. The transmitted audio data may be received and played by a RF receiving device such as radio set.

### BACKGROUND OF THE INVENTION

1. Field of the Invention

The present invention relates to a media player, particularly to a media player that employs a digital/analog/RF conversion unit to convert audio signals from digital (or analog) into RF signals, to enable RF receiving devices (e.g., radio or radio set) to receive and play the RF signals.

2. Brief Description of Related Art

In early time, music is stored on films and is played with a gramophone or a disc player, which reads tracks on films with a gramophone needle and plays the music through a speaker. However, the films are obsolete because they are difficult to preserve and cumbersome. Today, music is usually stored on tapes or CDs. However, magnetic particles on tapes may fall off after frequent use, thus the music quality is degraded gradually. CDs are featured with compact size, easy preservation, and high capacity, etc., and have become dominant music storing media. However, as technology advances, flash memory storage media are becoming widely used as storage media for multimedia data (e.g., MP3) due to their more compact size, portability, and high capacity. However, music stored in any of above storage media (tape, CD, flash memory) is in analog or digital signal form and can only be played with corresponding players, such as tape player, CDplayer, MP3 player, etc., in stead of with any other means. If the user only has a radio set or any other RF receiving device that can only receive RF signals, the known media players (tape player, CD player, MP3 player) is useless.

### SUMMARY OF THE INVENTION

The main object of the present invention is to provide a media player that reads external digital/analog audio signals, converts said digital/analog audio signals into RF signals with a converting unit, and then transmits the RF signals to enable radio sets or radio receivers to receive and play the RF signals.

To attain said object, the media player in the present invention comprises at least a processing unit, a reading unit, a converting unit, and a transmitting unit; said reading unit reads digital/analog audio signals from at least one type of storage media under the control of the processing unit, said converting unit converts the digital/analog audio signals into RF signals, and then the transmitting unit transmit the RF signals; thus RF receiving devices such as radio sets or radio receivers may receive and play the RF signals.

Said media player may read data from MP3 players, CD players, mini memory cards, or hard disks.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of the first embodiment of the present invention;

FIG. 2 is a perspective view of the first embodiment of the present invention;

FIG. 3 is a circuit block diagram of the present invention;

FIG. 4 shows the working status of the present invention;

FIG. 5 is a perspective view of the second embodiment of the present invention; and

FIG. 6 shows the working status of the second embodiment of the present invention.

### DETAILED DESCRIPTION OF THE PREFERRED EMBODIMENTS

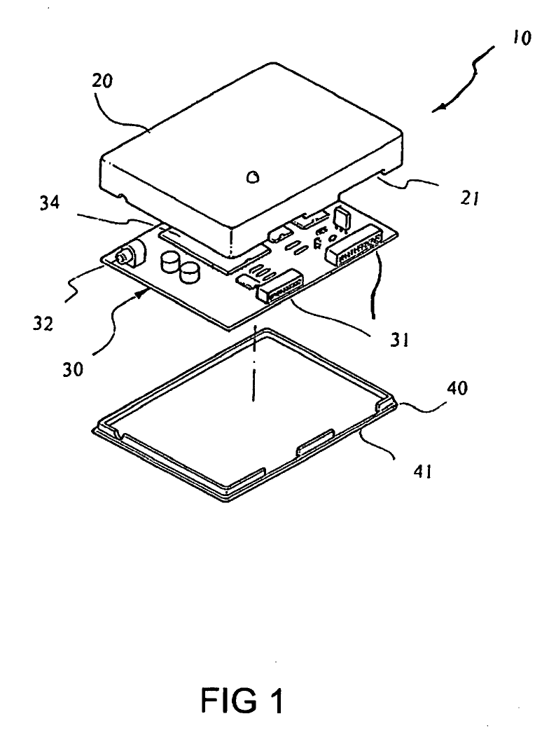

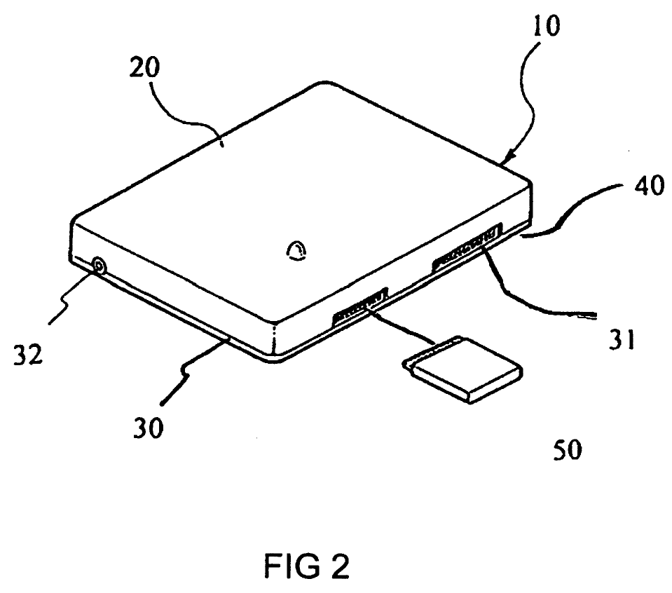

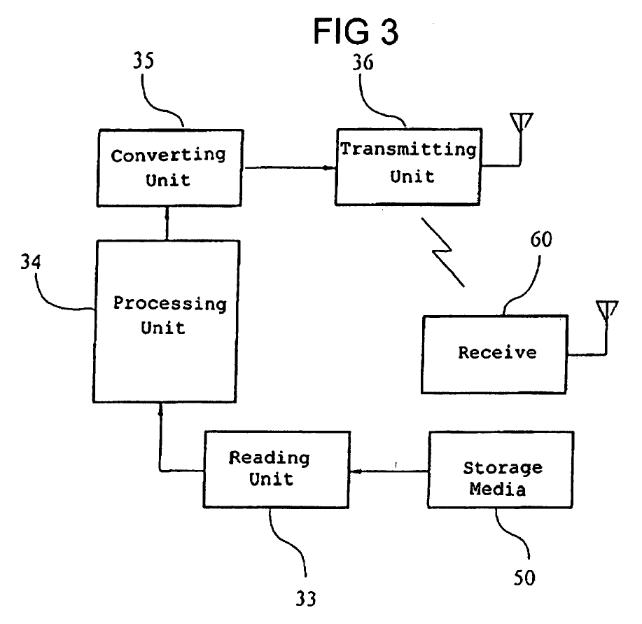

Referring to FIGS. 1 and 2, the media player 10 in the present invention comprises a top cover 20, a circuit board 30, and a bottom cover 40; said top cover 20 may be coupled with said bottom cover 40 to enclose said circuit board 30, and said top cover 20 and said bottom cover 40 have corresponding grooves 21 and 41 on their edges, respectively; when said grooves 21 and 41 are coupled to each other, said top cover 20 and said bottom cover 40 enclose said circuit board and leave a connector of said circuit board 30 outside of the cover to connector an external storage media 50 (as shown in FIG. 3).

Said connector 31 may be a USB port, COM1 port, memory card socket, IEEE1394 port, or IDE port, any of which may be connected to the storage media 50 to transfer digital/analog signals to the processing unit 34 on the circuit board 30. In addition, said circuit board 30 has a power plug 32 to supply power to the circuit board.

Said circuit board 30 (as shown in FIG. 3) comprises at least:
a reading unit 33 connected to said connector 31 and reads data from the external memory media 50 via said connector;
a processing unit 34, which is the main control unit that controls the reading unit 33 to read digital/analog audio data and transfers the audio data to the converting unit 35;
a converting unit 35 that converts digital audio data transferred from said processing unit 34 into analog signals and then into RF signals, or converts digital/analog audio data directly into RF signals;
a transmitting unit 36 that transmits said RF signals. Any FM receiver 60 (e.g., radio set) tuned to said RF signal frequency can receive said RF signals and play them.

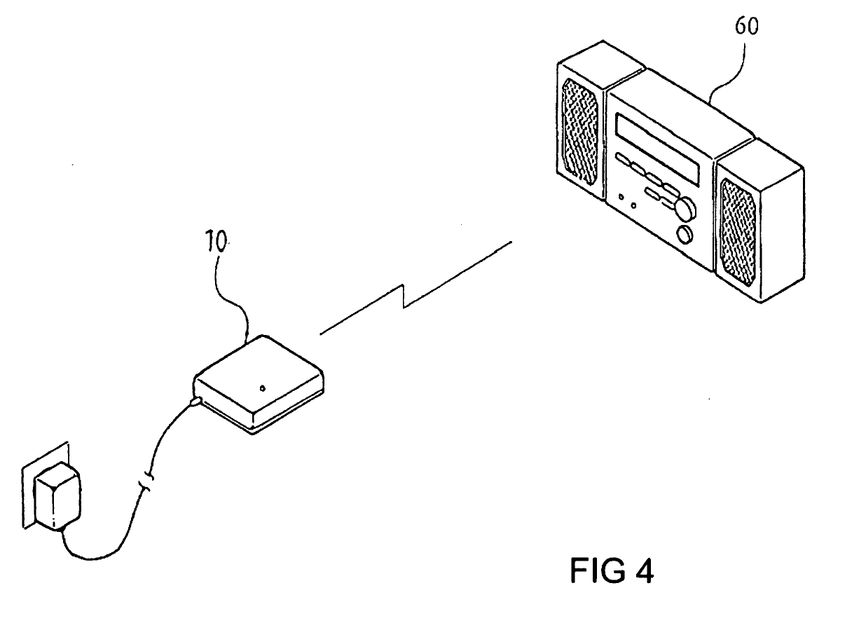

Referring to FIG. 4, said media player 10 may read audio data (e.g., MP3, WMA audio data) from a computer via said connector 31 or may be connected to an external storage media 50 (e.g., CD player, MDplayer, MP3 player, electronic memory card, or portable CD player) to read digital/analog audio data from said storage media 50 via said reading unit. In application, said processing unit 34 control said converting unit 35 to convert digital/analog audio data read by said reading unit 31 into RF signals and then control said transmitting unit 36 to transmit said RF signals. Then, any radio set 60 tuned to the frequency of said RF signals may receive said RF signals and then play them. Within the coverage of said transmitting unit 36, any radio set 60 may play the RF signals transmitted from said media player 10, thus the media player 10 serves as a music play center.

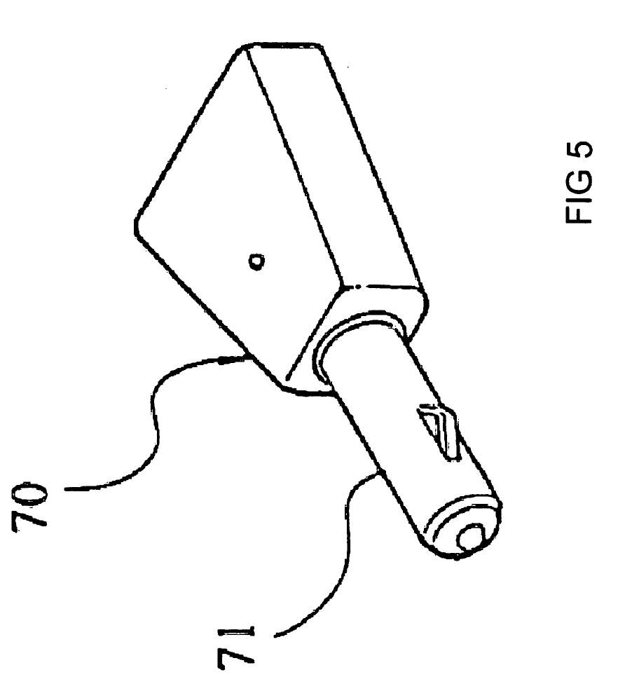

Referring to FIG. 5, another embodiment of the present invention; wherein said media player 70 is equipped with an onboard cigarette lighter plug 71, which is designed to work in an onboard cigarette lighter jack (not shown) to utilize automobile power supply. Similarly, the resulting RF signals from said media player are transferred into internal radio set 80 in the automobile to play the music with speakers in the automobile. In that way, the media player 70 may be used as music source for internal sound system of the automobile without any additional connecting wire.

In addition, the media player in the present invention may have at least a storing unit to store data read from the external storage media.

The converting unit in the present invention may be designed to convert digital/analog audio data into high frequency, infrared, laser, blue teeth, or other radio signals.

The reading unit 33, converting unit 35, and transmitting unit 36 in the present invention may be directly embedded in the processing unit.

In conclusion, the media player in the present invention may read audio signals from different external storage media and transmit the converted audio signals via the transmitting unit. Compared to existing music players that only play audio signals of corresponding audio formats, the media player becomes a music play center and also provides radio transmission function. It is an unprecedented invention and of great commercial value.

While the invention has been described with referencing to a preferred embodiment thereof, it is to be understood that modifications or variations may be easily made without departing from the spirit of this invention, which is defined by the appended claims.

1. A media player, comprising:
a reading unit, which is designed to read digital/analog audio data from an external storage media;
a processing unit, which controls said reading unit to read audio data and transfers said audio data to the converting unit;
a converting unit, which converts said audio data into RF signals; and
a transmitting unit, which amplifies said RF signals and then transmits them to enable audio sets to receive and play said RF signals.

2. A media player according to claim 1, wherein said reading unit is connected to a connector, in order to connect to the external storage media.

3. A media player according to claim 1, wherein said external storage media comprises a MP3 player, CD player, mini memory card, multimedia player, or any similar storage media.

4. A media player according to claim 1, wherein the transmitting formats of said transmitting unit comprise high frequency, infrared, laser, blue teeth, or any similar radio transmission format.

5. A media player according to claim 1, wherein said reading unit, converting unit, and transmitting unit are directly embedded in said processing unit.
